(19) United States
(12) Patent Application Publication
(10) Pub. No.: US 2017/0206371 A1
(43) Pub. Date: Jul. 20, 2017

(54) APPARATUS AND METHOD FOR MANAGING DOCUMENT BASED ON KERNEL

(71) Applicant: ELECTRONICS AND TELECOMMUNICATIONS RESEARCH INSTITUTE, Daejeon (KR)

(72) Inventors: Jangha KIM, Daejeon (KR); Sunghun KIM, Daejeon (KR); Minsung CHOI, Daejeon (KR); Guhyeon JEONG, Daejeon (KR); Hongchul KIM, Daejeon (KR)

(21) Appl. No.: 15/177,893

(22) Filed: Jun. 9, 2016

(30) Foreign Application Priority Data
Jan. 19, 2016 (KR) 10-2016-0006616

(51) Int. Cl. G06F 21/62; G06F 17/30; G06F 21/71

(52) U.S. Cl. CPC G06F 21/6218; G06F 21/71; G06F 17/30011; G06F 17/30091

(57) ABSTRACT

An apparatus and method for managing a document based on a kernel. The apparatus for managing a document based on a kernel includes a virtual file processing unit for creating file input/output information by filtering file input/output operations of a local operating system at the kernel level, a process information collection unit for collecting information about a process that is using a file, an access control unit for controlling access to the file using the file input/output information and the collected information about the process, and a document program processing unit for controlling a text editor in which the file is executed and for sending a sharing command to a document management server when the access to the file is determined to be approved access.

### CROSS REFERENCE TO RELATED APPLICATION

This application claims the benefit of Korean Patent Application No. 10-2016-0006616, filed Jan. 19, 2016, which is hereby incorporated by reference in its entirety into this application.

### BACKGROUND OF THE INVENTION

1. Technical Field

The present invention relates to technology for managing a document based on a kernel in order to share document files, built as a database and stored in a document management server, through the file system and interface of a user terminal.

2. Description of the Related Art

Enterprise Content Management (ECM) technology involves a centralized system for integrating and managing all processes that include creating, managing, and distributing all enterprise content, such as documents, website images, website source code, and the like.

With the rapid increases in the amount and variety of enterprise content, ECM is attracting a lot of attention because the systematic management of content may greatly contribute to the enhancement of competitiveness and improvement in productivity. As information technology is applied to entire business, enterprises are working on ways to effectively manage their digital content, such as file systems, DM/XML, documents, media, Enterprise Resource Planning (ERP), and the like.

Particularly in an environment based on a new business model generated by the introduction of e-business, the success of a business may depend on the effective management of content. Many enterprises make a lot of effort to manage content efficiently in order to enable employees to easily share information owned by a company and to make sound managerial decisions. As described above, with the growing need for content management systems, ECM is considered more important.

An ECM system realizes document centralization in such a way that all documents (or content) of an enterprise are stored in a central server and are prohibited from being stored on local disks, such as hard disks of users, removable storage media, and the like. Such document centralization enables the control of all documents created or updated by users (or employees) of the enterprise, whereby the documents of the enterprise may be prevented from being leaked or illegally used, and the risk of loss of documents may be reduced even if an employee leaves the company or transfers to another department.

Also, when there are a great number of servers and storage media, or when the servers and storage media are distributed, an ECM system is implemented to enable users to use the system as if they were connected to a single central storage, server (or a document management server) through a virtualization solution. Also, an ECM system enables sharing of a single document among multiple users and collaborative work on the document. For such collaborative work, the ECM system manages different versions of the document and the history of revisions to the document.

According to conventional document centralization technology, when a new document is created, the document is immediately registered in a server. That is, from the step of creating a file, the file is registered in the document management server and is saved only on the server. Particularly, whenever a document is created or saved, this event is hooked, whereby the document can be created or saved, in the document management server.

However, according to the conventional art, saving or creating a document is processed through a document management screen of a document management system. Particularly, when reading documents stored in the document management system or reading a list of all the documents stored therein, users must use the screen provided by the document management server rather than using a document explorer screen of a user terminal.

Accordingly, users who are accustomed to the screen of the user terminal may be inconvenienced when using the screen of the document management server, and may therefore avoid using it.

In order to solve this problem, there is provided a document management system architecture that provides the same interface as the file explorer of a user terminal used by the members of an organization so that users may easily and conveniently use the document management system. This architecture uses a method in which the events of the process of a text editor are hooked, but hooking the text editor events may not be used in an operating system in which a component of an application necessarily requires a digital signature, such as OS X. Therefore, there is the need for a document management technique that can be used in an environment in which event hooking is impossible.

In connection with this, Korean Patent Application Publication No. 10-2011-0112002 discloses a technology related to “Document centralization method in document management system.”

### SUMMARY OF THE INVENTION

An object of the present invention is to induce document management activation and document centralization by supporting sharing of restricted content and collaborative work on the content even in an environment in which application hooking is impossible and by providing an access path through which the content may be easily and quickly accessed.

Another object of the present invention is to provide a function of filtering file input/output routines at the same level as that provided by application hooking in an environment in which application hooking is impossible.

A further object of the present invention is to enable the application of a document management technique to an operating system to which a virtual file system is applied, such as OS X, UNIX, Linux, and the like, without using an application program hooking technique, which is limited to Windows OS.

Yet another object of the present invention is to automatically check out a file when launching a text editor, to check in the file when terminating the text editor, and to store shared information through extended file attributes.

Still another object of the present invention is to block access to a local DB by unapproved processes and unapproved users.

In order to accomplish the above object, an apparatus for managing a document based on a kernel according to the present invention includes a virtual file system processing unit for creating file input/output information by filtering file input/output operations of a local operating system at a kernel level; a process information collection unit for collecting information about a process that is using a file; an access control unit for controlling access to the file using the file input/output information and the collected information about the process; and a document program processing unit for controlling a text editor in which the file is executed and for sending a sharing command to a document management server if the access to the file is determined to be approved access.

The access control unit may check whether a file path of the file includes a local DB, check whether the text editor in which the file is executed is a registered text editor, check whether the file is a document file and check whether the access to the file is approved access.

The access control unit may block a process and a user, not approved to access the file, from accessing the local DB if the access to the file is determined to be unapproved access.

The access control unit may output a warning when the file is saved in a location that is not the local DB.

The document program processing unit may restart the text editor when a new document is created.

The document program processing unit may set the file to a locked state by checking out the file when the text editor is launched, and may check in the file when the text editor is terminated.

The virtual file system processing unit may share files stored in the document management server in a form of a local file system.

The document program processing unit may perform user authentication and be provided with a file corresponding to privileges of the authenticated user, the file being shared from the document management server via a gateway server.

The document program processing unit may perform sharing of the file by opening a session for file sharing with the gateway server if approval of the user authentication is obtained from the document management server.

The virtual file system processing unit, and the access control unit may be installed in a kernel space, and the process information collection unit and the document program processing unit may be installed in an agent space.

Also, a method for managing a document based on a kernel, which is performed by an apparatus for managing the document based on the kernel, includes hooking an OPEN function for processing file input/output at the kernel; checking whether a processing mode is a write mode; if the processing mode is the write mode, checking whether a file corresponding to the OPEN function exists; if the file exists, saving the file, and if the file does not exist, creating a new file; and controlling access to the file.

Controlling access to the file may include checking whether a file path of the file includes a local DB, checking whether a text editor in which the file is executed is a registered text editor, and checking whether the file is a document file.

If the file path includes the local DB, if the text editor is a registered text editor, and if the file is a document file, the method may further include checking out, by the text editor, the file from the document management server and allowing the file to be edited in the text editor.

If the file path includes the local DB, if the text editor is a registered text editor, and if the file is not a document file, the method may further include allowing access by the text editor to the file, which is a temporary file.

If the file path includes the local DB and if the text editor is not a registered text editor, the method may further include blocking access to the file.

If the file path does not include the local DB, if the text editor is a registered text editor, and if the file is a document file, the method may further include changing a location in which the file is to be saved to a mounted network drive.

If the file path does not include the local DB, if the text editor is not a registered text editor, and if the file is a document file, the method may further include blocking the text editor from using a network drive.

Checking whether the file path of the file includes the local DB may be configured to determine whether a file path of the file, which is executed in the text editor, includes the local DB that is mounted as a network drive.

Checking whether the file is a document file may be configured to check whether an extension of the file is an extension corresponding to a document file.

The method may further include hooking a CLOSE function at the kernel, and performing a file save event in a state in which storing data of the file has been completed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a document management system based on a kernel according to an embodiment of the present invention;

FIG. 2 is a block diagram illustrating the configuration of an apparatus for managing a document based on a kernel according to an embodiment of the present invention;

FIG. 3 is a flowchart illustrating a method for managing a document based on a kernel according to an embodiment of the present invention; and

FIG. 4 is a flowchart illustrating a method for controlling access to a file at step S330 of FIG. 3.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment according to the present invention will be described in detail with reference to the accompanying drawings.

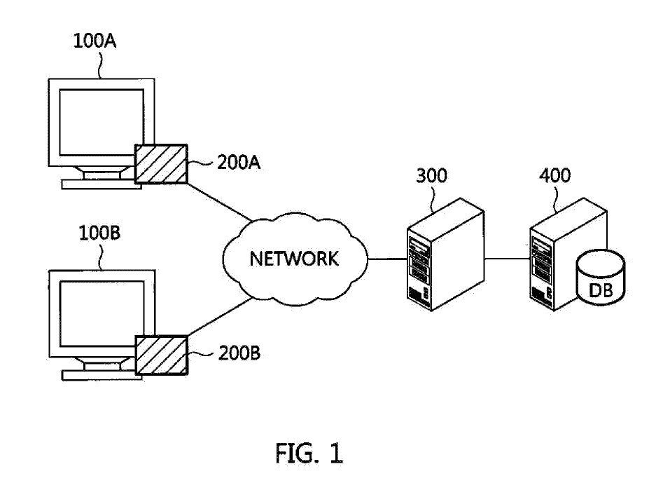

FIG. 1 is a view illustrating a document management system based on a kernel according to an embodiment of the present invention.

As illustrated in FIG. 1, the kernel-based document management system includes user terminals 100a and 100b, a gateway server 300 and a document management server 400. The user terminals 100a and 100b may be implemented so as to include a kernel-based document management apparatus 200, or may be connected to the kernel-based document management apparatus 200 via a network. Also, the user terminal 100 is connected to the gateway server 300 via a network, and the document management server 400 may include a database for storing data such as files, documents, and the like.

First, the user terminal 100 means a common computing terminal used by a user, such as a PC, a notebook, a tablet PC, a smart phone, and the like. The user terminal has an operating system installed therein and a local storage medium for storing data.

Here, the operating system installed in the user terminal 100 means the local operating system. The local operating system provides a file explorer for searching for a file, for example, a document stored in the local storage medium or the like. The file explorer is an explorer in the form of a window having a Graphic User Interface (GUI), and represents a directory path as a hierarchical structure using folders. Also, using the file explorer, a user may check the context menu of a certain file or folder, and may be provided with menu items applicable to the file or folder selected using a mouse cursor in the form of a pop-up menu.

For example, if the local operating system is Apple's OS X, the file explorer is Finder, but Finder does not provide a context menu in the explorer window, unlike Window Explorer in Windows OS.

In order to overcome this functional limitation, the local operating system mounts a storage medium as a drive, and thereby enables searching, for a file using a directory structure. In other words, other than local storage media, an external storage medium or a storage space provided over a network may be mounted as a drive. Accordingly, a storage medium of the terminal of another user, which is connected over a network, may be mounted as a network drive.

Also, the kernel-based document management apparatus 200 controls a text editor of the local operating system and collects the full path of the execution file of a program corresponding to a process ID requested by the user terminal 100 and information about open files. Also, the kernel-based document management apparatus 200 may perform a document version control function or a document collaboration function, among the functions of the document management server 400.

The kernel-based document management apparatus 200 is automatically started when the local operating system of the user terminal 100 boots, and may perform a process of authenticating a user. The kernel-based document management apparatus 200 may provide an interface with the gateway server 300, and may configure and provide a screen for authenticating a user in order to connect to a network drive.

Next, the gateway server 300 enables the user terminal 100 to access a document managed by the document management server 400. Here, the gateway server 300 allows the user terminal 100 to access the document management server 400 as a network drive.

The gateway server 300 may hierarchically categorize the documents stored in the document management server 400. The hierarchically categorized documents may be changed so as to correspond to the file system structure of the local operating system. That is, the hierarchical structure of the document list is made to correspond to the file system structure of the local operating system.

Also, the gateway server 300 requests the list of documents, categorized based on attributes so as to have a hierarchical structure, from the document management server 400, and receives the list of the documents from the document management server 400. In the received list of documents, a unique identifier (ID) is assigned to each of the documents. When a specific document is selected, the gateway server 300 may request the content of the corresponding document from the document management server 400 using the unique ID of the selected document.

Also, the gateway server 300 provides the function of a file-sharing server by which files can be shared through a network drive of the local operating system. When the user terminal 100 requests the gateway server 300 to mount a network drive, the gateway server 300 mounts the network drive on the file system, structure corresponding to the document list having the hierarchical structure.

Here, the local operating system of the user terminal uses a file-sharing protocol in order to share files stored in a storage medium with the terminal of another user, connected over a network.

Here, the file-sharing protocol means a protocol for handling the files stored in the terminal of another user using the same interface as the file explorer of the user terminal. In other words, when the user terminal 100 mounts the storage medium of the terminal of another user as a drive using the file-sharing protocol, files may be managed using the same interface as if a local storage medium were mounted. For example, if the local operating system is Apple's OS X, the file-sharing protocol may be the AFP protocol or the SMB protocol.

Also, when the local operating system of the user terminal 100 mounts a network drive using the file-sharing protocol, the gateway server 300, which is the file-sharing server, performs user authentication. Here, the gateway server 300 performs the user authentication to correspond to a user authentication policy managed by the document management server 400.

The gateway server 300 delivers information about user authentication, which is received from the user terminal 100, to the document management server 400 and checks the result of the user authentication. Then, depending on the result of the user authentication, the gateway server 300 determines whether to accept the request from the user terminal 100. If the user is authenticated by the document management server 400, the gateway server 300 opens a session for file sharing with the user terminal 100 and starts sharing files. Here, the gateway server 300 shares only the files corresponding to the privileges of the authenticated user, and the range to be shared may be predefined in the document management server 400.

The gateway server 300 functions as a file-sharing server based on the file-sharing protocol. If the local operating system is OS X, the gateway server 300 functions as an AFP server and an SMB server, and mounts a document of the document management server 400 as a network drive so that the document may be shared as a shared file over the network.

In other words, the gateway server 300 connects the file-sharing session to a network drive. For example, if the local operating system is OS X, the gateway server 300 connects the file-sharing session to a network drive formatted with the Hierarchical File System Plus (HFS+) of OS X, which supports extended file attributes.

Here, the kernel-based document management apparatus 200 receives the shared information from the gateway server 300 using the file-sharing protocol. For example, assuming that the local operating system of the user terminal 100 is Apple's OS X, the shared information may be stored in the extended file attributes, and may then be sent to the user terminal 100.

If a specific file is selected, the kernel-based document management apparatus 200 receives shared information, which is information about a sharing function corresponding to the selected file, from the gateway server 300. Here, the shared information may be received using, the predefined name of the extended file attributes for each of the files in the connected network drive.

Common information associated with the selected file, such as the name, size, content, author, and the like, may be acquired using the Application Programming Interface (API) provided by the sharing protocol. However, an API, by which the ID of the corresponding file (Object ID) in the document management server 400, the user's privileges in the document management server, information about the locked state of the document, the version of the document, and the like, can be directly acquired, is not provided. Therefore, in order to receive such information about the file from the gateway server 300, the kernel-based document management apparatus 200 uses an API that is capable of reading and writing extended file attributes.

Next, the document management server 400 approves a user depending on the result of user authentication and shares documents corresponding to the access permission of the user in the file-sharing session. Upon receiving a request for a file list, the document management server 400 sends the gateway server 300 the list of documents to which access is allowed. Also, upon receiving a request for a file, the document management server 400 sends the gateway server 300 content corresponding to the document, to which access is allowed.

The document management server 400 is a kind of ECM system, and means a server for managing enterprise content, such as documents, files, and the like, stored in a database, storage, or repository. For the convenience of description, all enterprise content stored and managed by the document management server 400 is called “documents”. Each document stored in the document management server 400 has attributes that include a user, the department to which the user belongs, a field associated with the document, a security level, and the like. Accordingly, the documents may be grouped or divided based on such attributes.

For example, if the documents are subdivided based on a field, the documents may be classified so as to have a hierarchical structure based on the fields. Also, if the documents are subdivided based on the department, the documents may be classified so as to have a hierarchical structure based on the departments. The document management server 400 may classify the documents, stored in the database, based on the attributes, and may provide the classified documents to the user terminal 100. For the convenience of description, the document management server 400 is described as storing documents, but without limitation to this, a separate database connected to the document management server 400 may also store documents.

Also, the document management server 400 enables multiple users to share a single document for collaboration. If a user checks out a document in order to use the document, the document management server 400 sets the corresponding document to a locked state in order to prevent another user from updating the document. Conversely, if the user checks in the document after using the document, the document management server 400 unlocks the document in order to enable another user to use the document.

Also, the document management server 400 manages versions of a document, and thereby may manage the history of revisions to the document. Accordingly, a user may read not only the latest document but also the previous version of the document. When a user updates a created document, the document management server 400 stores both the content of the first created document and the updated document as different versions of the document. Then, based on each document version, the document management server 400 may store and manage the time at which the corresponding version of the document is updated, details about the update, information about the user who updated the document, and the like.

Also, the document management server 400 authenticates a user and controls access to documents. The document management server 400 authenticates a user and approves access permission corresponding to the user, and allows only a user having suitable access permission to read or update the stored documents.

When it is connected to a network drive using a file-sharing protocol, the file directory of the document management server 400 is mounted in the directory “/Volume/Docs”. Accordingly, a user may access the document of the document management server 400 as a file on the network drive.

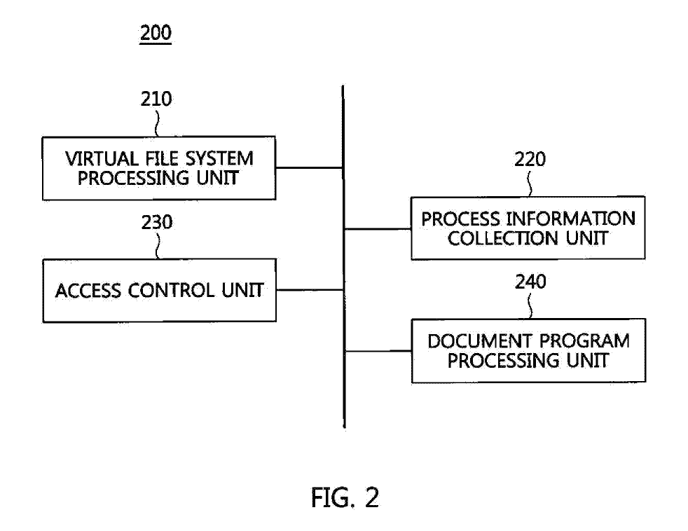

FIG. 2 is a block diagram illustrating the configuration of an apparatus for managing a document based on a kernel according to an embodiment of the present, invention.

As illustrated in FIG. 2, the kernel-based document management apparatus 200 includes a virtual file system processing unit 210, a process information collection unit 220, an access control unit 230, and a document program processing unit 240. In the kernel-based document management apparatus 200, the virtual file system processing unit 210 and the access control unit 230 are installed in kernel space, and the process information collection unit 220 and the document program processing unit 240 are installed in an agent space. Here, the kernel space may be implemented in such a way that necessary functions are added to the input/output module of the kernel file system in the user terminal 100. Also, the file system may be HFS+ of OS X.

First, the virtual file system processing unit 210 creates file input/output information by filtering file input/output operations of the local operating system at the kernel level. The virtual file system processing unit 210 configures a file-sharing session with the user terminal 100 using a file-sharing protocol and shares the document storage directory of the document management server 400, which is configured in the form of a directory, as a directory of the local file system.

The file-sharing protocol means a protocol for handling files stored in the terminal of another user using the same interface as the file explorer of the user terminal 100. Here, a storage medium connected via a network is mounted as a drive using the file-sharing protocol, whereby files may be managed using the same interface as if a local storage medium were mounted. For example, if the local operating system is Apple's OS X, the file-sharing protocol may be the AFP protocol or the SMB protocol.

The process information collection unit 220 collects information about a process that is using a file.

The access control unit 230 controls access to a file using file input/output information and the collected information about the process.

Also, the access control unit 230 checks whether the path of a file includes a local DB, whether the text editor in which the file is executed is a registered text editor, and whether the file is a document file. Then, the access control unit 230 determines whether access to the file is approved using the result of the determination on whether the path, of a file includes a local DB, whether the text editor in which the file is executed is a registered text editor, and whether the file is a document file.

If access to the file is determined to be unapproved access, the access control unit 230 blocks the process, and user, not approved to access the file, from accessing the local DB. Then, if an attempt is made to save the file in a location that is not the local DB, the access control unit 230 outputs a warning so as to prompt to save the file in the local DB.

The document program processing unit 240 controls the start, termination, and restart of the text editor in which a file is executed, and sends a sharing command to the document management server 400 if access to the file is determined to be approved access. Here, the sharing command may be created by the access control unit 230 after determining whether access to the file is approved access.

Also, when a new document, is created, the document program processing unit 240 restarts a text editor. Also, when the text editor is started, the document program processing unit 240 checks out a file so as to set the file to a locked state. When the text editor is terminated, the document program processing unit 240 checks in the file.

Also, the document program processing unit 240 performs user authentication, and may be provided with a file corresponding to the access, permission of the authenticated user, which is shared from the document management server 400 via the gateway server 300. If approval of user authentication is obtained from the document management server 400, the document program processing unit 240 opens a session for file sharing with the gateway server, and thereby performs file sharing.

Also, when access to a file is determined to be unapproved access, the document program processing unit 240 may output a warning message to a user.

As described above, the kernel-based document management apparatus 200 integrates and analyzes a kernel-based file input/output mechanism and information about a document access process in the operating system in which process hooking is restricted, such as OS X, whereby sharing of restricted files and concurrent collaborative work on the files may be supported. Also, the kernel-based document management apparatus 200 may provide an access path through which files may be easily, and quickly accessed, and enables document management activation and document centralization to be applied to various operating systems.

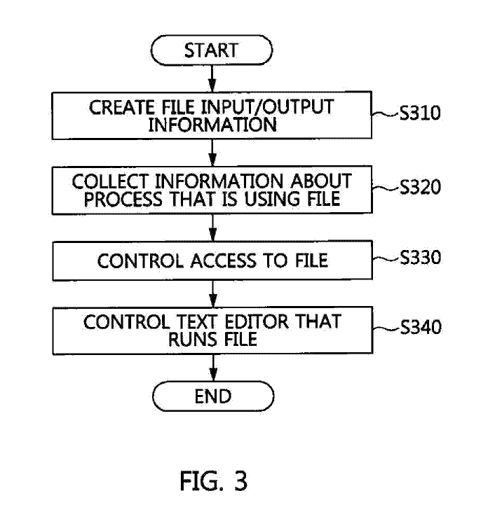

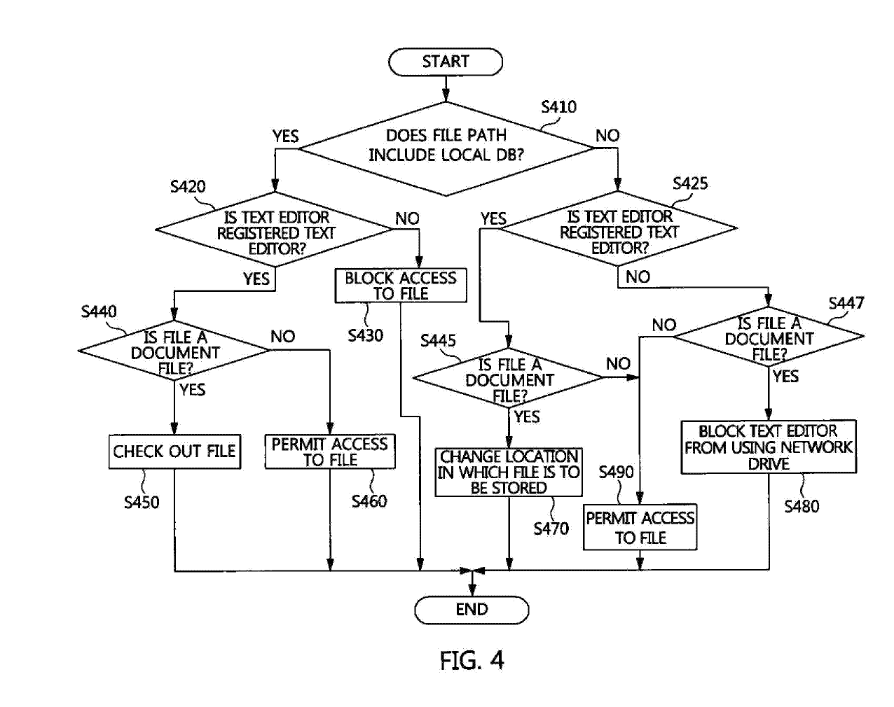

Hereinafter, a method for managing a document based on a kernel according to an embodiment of the present invention is described in detail with reference to FIGS. 3 and 4.

FIG. 3 is a flowchart illustrating the method for managing a document based on a kernel according to an embodiment of the present invention.

First, the kernel-based document management apparatus 200 creates file input/output information at step S310.

The kernel-based document management apparatus 200 creates the file input/output information by filtering file input/output operations of the local operating system at the kernel level.

Next, the kernel-based document management apparatus 200 collects information about a process that is using a file at step S320.

Then, the kernel-based document management apparatus 200 controls access to the file using the file input/output information and the information about the process at step S330.

When an OPEN function for processing file input/output is hooked at the kernel level, the kernel-based document management apparatus 200 checks whether the mode for processing the file input/output is a write mode and whether the corresponding file exists. If the corresponding file exists, a file save event is performed. Conversely, if the corresponding file does not exist, a file creation event is performed.

Also, when a CLOSE function is hooked in the virtual file system, the kernel-based document management apparatus 200 performs a file save completion event. After performing the file save event, file creation event, or file save completion event, when a function related to the file is executed, the kernel-based document management apparatus 200 manages the file and controls access to the file.

FIG. 4 is a flowchart illustrating the method for controlling access to a file at step S330 of FIG. 3.

First, the kernel-based document management apparatus 200 checks whether a file path includes a local DB mounted on a network drive at step S410.

Then, the kernel-based document management apparatus 200 checks whether the text editor is a registered editor using information about the process that accesses the file at steps S420 and S425.

If the file path includes a local DB, and if the text editor is not a registered text editor, the kernel-based document management apparatus 200 signals that an abnormal process is attempting to access the file and blocks the corresponding process from accessing the file at step S430.

Next, the kernel-based document management apparatus 200 checks whether the file is a document file at steps S440, S445, and S447. Here, the kernel-based document management apparatus 200 may check whether the file is a document file by checking whether the extension of the file is an extension corresponding to a document file.

If the file path includes a local DB, if the text editor is a registered text editor, and if the file is a document file, the kernel-based document management apparatus 200 checks out the corresponding file at step S450. The kernel-based document management apparatus 200 requests the gateway server 300 to check out the file, and changes the state to a document editing state.

Meanwhile, if the file path includes a local DB, if the text editor is a registered text editor, and if the file is not a document file, the kernel-based document management apparatus 200 allows access to the file at step S460.

In this case, the kernel-based document management apparatus 200 determines that the corresponding file is a temporary file used by the text editor, and allows access to the file for normal operation.

If the file path does not include a local DB, if the text editor is a registered text editor, and if the file is a document file, the kernel-based document management apparatus 200 changes the location in which the file is to be saved to the mounted network drive at step S470.

If the file path does not include a local DB, if the text editor is not a registered text editor, and if the file is a document file, the text editor is blocked from using the network drive at step S480. The kernel-based document management apparatus 200 announces that the unapproved text editor cannot use the mounted network drive and blocks the text editor from accessing the mounted network drive.

Also, if the file path does not include a local DB, if the text editor is not a registered text editor, and if the file is not a document file, the kernel-based document management apparatus 200 determines that the access to the file is not access to a centralized document but a file input/output operation necessary in the operating system, and thus allows the access to the corresponding file at step S490.

Describing FIG. 3 again, the kernel-based document management apparatus 200 controls the text editor in which a file is executed at step S340.

Because the kernel-based document management apparatus 200 controls access by a text editor to a file after authenticating a user, only an approved text editor may access the local DB, which is the mounted network drive, and may then create, update, and edit files in the local DB. That is, the kernel-based document management apparatus 200 blocks unapproved processes, such as malware, from accessing the documents stored in the local DB.

According to the present invention, because sharing of restricted content and collaborative work on the content are supported even in an environment in which application hooking is impossible, and because an easy and quick access path to the content is provided, document management activation and document centralization may be induced.

Also, according to the present invention, in an environment in which application hooking is impossible, a function of filtering file input/output routines may be provided at the same level as that provided by application hooking.

Also, according to the present invention, because an application hooking technique, which is limited to Windows OS, is not used, a document management technique may be applied to an operating system to which a virtual file system is applied, such as OS X, UNIX, Linux, and the like.

Also, according to the present invention, a file may be automatically checked out when launching a text editor and checked in when terminating the text editor, and shared information may be stored through extended file attributes.

Also, according to the present invention, access to a local DB by unapproved processes and unapproved users may be blocked.

As described above, an apparatus and method for managing documents based on a kernel according to the present invention are not limitedly applied to the configurations and operations of the above-described embodiments, but all or some of the embodiments may be selectively combined and configured so that the embodiments may be modified in various ways.

1. (canceled)

2. An apparatus for managing a document based on a kernel, comprising:
a virtual file system processing unit for creating file input/output information by filtering file input/output operations of a local operating system at a kernel level;
a process information collection unit for collecting information about a process that is using a file;
an access control unit for controlling access to the file using the file input/output information and the collected information about the process; and
a document program processing unit for controlling a text editor in which the file is executed and for sending a sharing command to a document management server if the access to the file is determined to be approved access, wherein the access control unit is configured to:
check whether a file path of the file includes a local DB;
check whether the text editor in which the file is executed is a registered text editor;
check whether the file is a document file; and
check whether the access to the file is approved access.

3. The apparatus of claim 2, wherein the access control unit blocks a process and a user, not approved to access the file, from accessing the local DB if the access to the file is determined to be unapproved access.

4. The apparatus of claim 2, wherein the access control unit outputs a warning when the file is saved in a location that is not the local DB.

5. The apparatus of claim 2, wherein the document program processing unit restarts the text editor when a new document is created.

6. The apparatus of claim 2, wherein the document program processing unit sets the file to a locked state by checking out the file when the text editor is launched, and checks in the file when the text editor is terminated.

7. The apparatus of claim 2, wherein the virtual file system processing unit shares files stored in the document management server in a form of a local file system.

8. The apparatus of claim 2, wherein the document program processing unit performs user authentication and is provided with a file corresponding to privileges of the authenticated user, the file being shared from the document management server via a gateway server.

9. The apparatus of claim 8, wherein the document program processing unit performs sharing of the file by opening a session for file sharing with the gateway server if approval of user authentication is obtained from the document management server.

10. The apparatus of claim 2, wherein the virtual file system processing unit and the access control unit are installed in a kernel space, and the process information collection unit and the document program processing unit are installed in an agent space.

11. (canceled)

12. A method for managing a document based on a kernel, which is performed by an apparatus for managing the document based on the kernel, comprising:
hooking an OPEN function for processing file input/output at the kernel;
checking whether a processing mode is a write mode;
if the processing mode is the write mode, checking whether a file corresponding to the OPEN function exists;
if the file exists, saving the file, and if the file does not exist, creating a new file; and
controlling access to the file, wherein controlling access to the file comprises:
checking whether a file path of the file includes a local DB;
checking whether a text editor in which the file is executed is a registered text editor; and
checking whether the file is a document file.

13. The method of claim 12, further comprising,
if the file path includes the local DB, if the text editor is a registered text editor, and if the file is a document file, checking out, by the text editor, the file from a document management server and allowing the file to be edited in the text editor.

14. The method of claim 12, further comprising,
if the file path includes the local DB, if the text editor is a registered text editor, and if the file is not a document file, allowing access by the text editor to the file, which is a temporary file.

15. The method of claim 12, further comprising,
if the file path includes the local DB and if the text editor is not a registered text editor, blocking access to the file.

16. The method of claim 12, further comprising,
if the file path does not include the local DB, if the text editor is a registered text editor, and if the file is a document file, changing a location in which the file is to be saved to a mounted network drive.

17. The method of claim 12, further comprising,
if the file path does not include the local DB, if the text editor is not a registered text editor, and if the file is a document file, blocking the text editor from using a network drive.

18. The method of claim 12, wherein checking whether the file path of the file includes the local DB is configured to determine whether a file path of the file, which is executed in the text editor, includes the local DB that is mounted as a network drive.

19. The method of claim 12, wherein checking whether the file is a document file is configured to check whether an extension of the file is an extension corresponding to a document file.

20. The method of claim 12, further comprising,
hooking a CLOSE function at the kernel; and
performing a file save event in a state in which storing data of the file has been completed.
